(19) United States
(12) Patent Application Publication
(10) Pub. No.: US 2010/0242283 A1
(43) Pub. Date: Sep. 30, 2010

(54) METHOD FOR FINISHING A GEAR SURFACE

(75) Inventors: Travis M. Thompson, Ann Arbor, MI (US); Jeffrey R. Lee, Tipton, MI (US); Stephen D. Doubler, Rochester Hills, MI (US); Richard Vriesen, LaSalle (CA)

Correspondence Address: VIVACQUA LAW, PLLC, 455 East Eisenhower Parkway, Suite 200, ANN ARBOR, MI, 48108, US

(73) Assignee: GM GLOBAL TECHNOLOGY OPERATIONS, INC., Detroit, MI (US)

(21) Appl. No.: 12/414,221

(22) Filed: Mar. 30, 2009

(51) Int. Cl. B23P 15/14; B21D 53/28; G05B 19/4097

(52) U.S. Cl. 29/893.3; 29/893; 700/173

(57) ABSTRACT

A method for manufacturing a gear having a plurality of gear teeth includes the steps of: determining a desired finished gear characteristic, determining a reference feature on the gear to establish an origin on the gear, determining an unfinished dimension of a surface of at least one of the plurality of gear teeth relative to the origin, estimating a desired stock removal that will achieve the desired finished gear characteristic, finishing the gear using a finishing tool, determining a finished dimension of the surface of the at least one of the plurality of gear teeth relative to the origin, determining actual stock removal by comparing the unfinished dimension with the finished dimension, and comparing the actual stock removal with the desired stock removal.

### FIELD

The present disclosure relates to a method for finishing a gear surface, and more particularly to a method for finishing a gear surface by determining actual stock removal and actual stock divide.

### BACKGROUND

The statements in this section merely provide background information related to the present disclosure and may or may not constitute prior art.

In many applications, including automotive transmission gear sets, individual gears must have gear teeth that are precisely finished. Typically, the stock removal for a given gear is estimated prior to finishing of the gear teeth surfaces. Currently there is no direct way to verify that the stock removal and stock divide assumptions and calculations are correct on hard gear finished parts. Stock divide is inferred from undercut size and stock removal is inferred by calculations based on measurements taken over balls, which is taken at a single location at mid tooth height. At best, over ball measurements and subsequent calculations only give an average stock removal at the point in which the ball contacted the flanks of the gear teeth. Thus, no information is known about the stock removal at any other point of the gear flank. In addition, existing measurements do not allow verification that stock removal is common between gear finishing machines and production facilities on the same part. Furthermore, existing measurements do not allow verification that the hard finishing operation is performing the left to right flank stock divide properly.

Incorrect stock removal and stock divide calculations raise the cost and lower the durability of finished parts. Regarding durability, the ability to quantify/control stock removal and divide has impact on uniformity of case depth and residual compressive stress that directly relates to pitting life on carburized gears. Regarding cost, optimization of stock removal and stock divide reduces tool cost that thereby lowers piece price. Accordingly, there is a need in the art for an improved method of determining stock removal and stock divide of a gear.

### SUMMARY

The present invention provides a method for manufacturing a gear having a plurality of gear teeth. The method includes the steps of: determining a desired finished gear characteristic, determining a reference feature on the gear to establish an origin on the gear, determining an unfinished dimension of a surface of at least one of the plurality of gear teeth relative to the origin, estimating a desired stock removal that will achieve the desired finished gear characteristic, finishing the gear using a finishing tool, determining a finished dimension of the surface of the at least one of the plurality of gear teeth relative to the origin, determining actual stock removal by comparing the unfinished dimension with the finished dimension, and comparing the actual stock removal with the desired stock removal.

In another aspect of the present invention, determining the reference feature further comprises marking the workpiece.

In yet another aspect of the present invention, determining the reference feature further comprises identifying a pre-existing feature on the gear.

In yet another aspect of the present invention, the method further comprises adjusting the finishing operation to achieve the desired stock removal during the finishing operation.

In yet another aspect of the present invention, adjusting the finishing operation further comprises changing the target size produced in the finishing operation.

In yet another aspect of the present invention, the method further comprises determining the actual stock divide by comparing the actual stock removal of a pair of adjacent surfaces of the plurality of gear teeth.

In yet another aspect of the present invention, the method further comprises adjusting the finishing operation to achieve the desired stock divide in the finishing operation.

In yet another aspect of the present invention, adjusting the finishing operation includes compensating for synchronization variation and deflection of the finishing tool using machine control.

In yet another aspect of the present invention, the unfinished dimension is an unfinished profile and the finished dimension is a finished profile, determining the unfinished and finished profiles further comprises tracing the surface from a root to a tip of at least one of the plurality of gear teeth.

In yet another aspect of the present invention, the method further comprises determining at least three unfinished surface profiles and at least three finished surface profiles of the surface of the at least one of the plurality of gear teeth.

In yet another aspect of the present invention, the method further comprises tracing the surface along a length of at least one of the plurality of gear teeth.

In yet another aspect of the present invention, the method further comprises determining substantially an entire surface topography of at least one of the plurality of gear teeth.

In yet another aspect of the present invention, the method further comprises adjusting roughing tooling based on the actual stock removal.

In yet another aspect of the present invention, the method further comprises adjusting process parameters based on the actual stock removal.

In yet another aspect of the present invention, the method further comprises adjusting heat treatment of an unfinished gear based on the actual stock removal.

In yet another aspect of the present invention, the unfinished surface profile and the finished surface profile are on a same plane.

In yet another aspect of the present invention, the finishing step further comprises a gear honing process.

In yet another aspect of the present invention, finishing the gear further includes a gear grinding process.

In yet another aspect of the present invention, finishing the gear further includes a gear shaving process.

In yet another aspect of the present invention, a method of finishing a gear after a roughing process is provided. The method includes the steps of: determining a desired finished gear characteristic, determining a reference feature on the gear to establish an origin, determining an unfinished surface dimension of at least one of the plurality of gear teeth relative to the origin, estimating a desired stock removal from the gear that will achieve the desired finished gear characteristic, finishing the gear using a finishing tool, determining a finished surface dimension of at least one of the plurality of gear teeth relative to the origin, determining actual stock removal in the finishing process by comparing the unfinished dimension with the finished dimension, comparing the actual stock removal with the desired stock removal, and adjusting at least one of the roughing process and finishing the gear to achieve the desired stock removal by finishing the gear.

In yet another aspect of the present invention, the unfinished surface dimension is an unfinished surface profile and the finished surface dimension is a finished surface profile.

In yet another aspect of the present invention, the unfinished surface profile and the finished surface profile are on a same plane.

In yet another aspect of the present invention, the method further comprises determining the actual stock divide by comparing the actual stock removal of a pair of adjacent surfaces of the plurality of gear teeth.

In yet another aspect of the present invention, the method further comprises adjusting the finishing operation to achieve the desired stock divide in the finishing operation.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a perspective view of an exemplary gear manufactured according to the principles of the present invention;

FIG. 2 is a cross sectional view of a gear tooth of FIG. 1; and

FIG. 3 is a flow chart of a method for finishing the gear illustrated in FIGS. 1 and 2 according to the principles of the present invention.

### DETAILED DESCRIPTION

The following description is merely exemplary in nature and is not intended to limit the present disclosure, application, or uses.

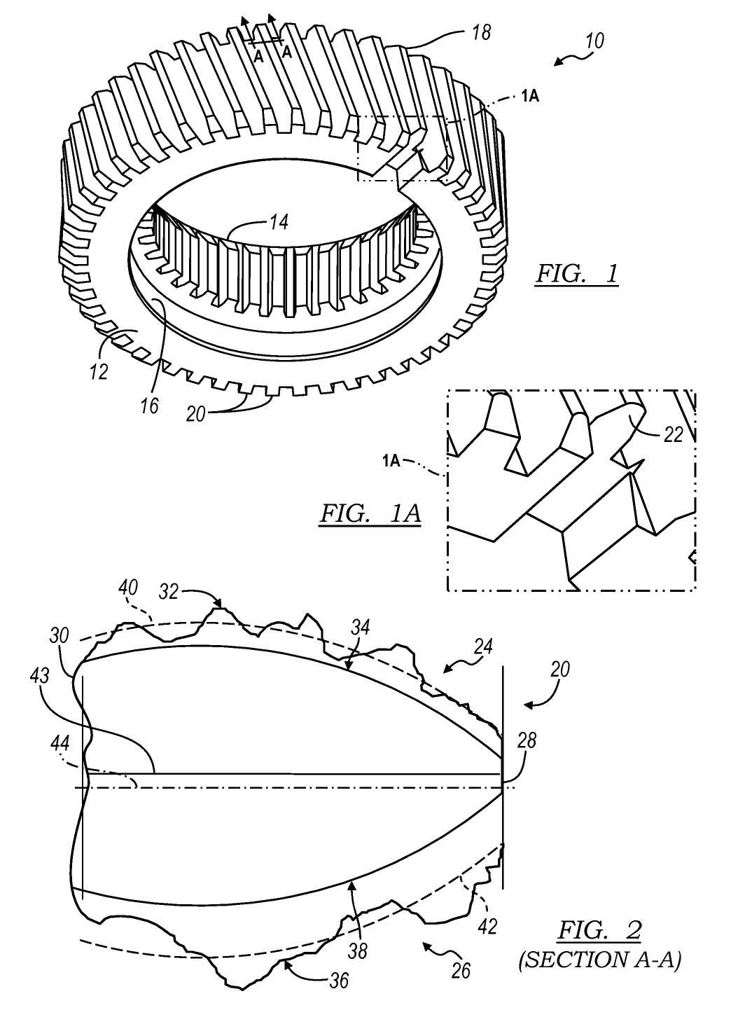

With reference to FIG. 1, an exemplary workpiece for use with the present invention is designated by the reference number 10. In the example provided, the workpiece 10 is a cylindrical gear, though the workpiece 10 may be other types of gears without departing from the scope of the present invention. The workpiece 10 includes a first side 12 disposed opposite a second side 14. The workpiece 10 further includes an inner surface 16 and an outer surface 18. A plurality of gear teeth 20 are disposed on the outer surface 18. Each gear tooth 20 extends from the first side 12 to the second side 14. In the example provided, the gear teeth 20 are disposed at an angle with respect to the first side 12 and the second side 14 (i.e. the gear teeth 20 are helical gear teeth). However, it should be appreciated that the gear teeth 20 may be arranged on the outer surface 18 or on the inner surface 16 in other configurations and angles without departing from the scope of the present invention. The gear teeth 20 typically cooperate with other gear teeth on other gears (not shown) to form gear sets operable to transmit torque therebetween. A reference mark or reference feature 22 is determined using the method of the present invention on the first side 12, as shown in FIG. 1A, and as will be described in greater detail below. In the example provided, the reference feature 22 is a cut portion or notch disposed on the first side 12 of the workpiece 10. The reference feature 22 preferably extends from the inner surface 16 to the outer surface 18 and is aligned with one of the plurality of gear teeth 20. However, the reference feature 22 may have any shape, be at any location on the workpiece 10, and may be a pre-existing feature on the workpiece 10, so long as the reference feature 22 identifies the orientation of the workpiece 10 before and after a finishing process.

Referring now to FIG. 2, one of the plurality of gear teeth 20 is shown in a cross sectional view taken at line A-A. The gear tooth 20 has a first flank 24 disposed opposite a second flank 26. The first flank 24 is located between a gear tip 28 and a root portion 30. Before the gear finishing process, the first flank 24 has a first unfinished surface profile 32. The unfinished surface profile 32 represents the rough, unfinished surface of the first flank 24 after forming or hobbing of the workpiece 10. It should be appreciated that the first unfinished surface profile 32 illustrated in FIG. 2 is exemplary and the first flank 24 may have any unfinished profile without departing from the scope of the present invention. After the gear finishing process of the present invention, the first flank 24 has a first finished surface profile 34. The first finished surface profile 34 represents the smooth, finished surface of the first flank 24 after removal of material from the first flank 24 of the workpiece 10.

The second flank 26 also is located between the gear tip 28 and the root portion 30. Before the gear finishing process, the second flank 26 has a second unfinished surface profile 36. The unfinished surface profile 36 represents the rough, unfinished surface of the second flank 26 after forming or hobbing of the workpiece 10. It should be appreciated that the second unfinished surface profile 36 illustrated in FIG. 2 is exemplary and the second flank 26 may have any unfinished profile without departing from the scope of the present invention. After the gear finishing process of the present invention, the second flank 26 has a second finished surface profile 38. The second finished surface profile 38 represents the smooth, finished surface of the second flank 26 after removal of material from the second flank 26 of the workpiece 10.

The first flank 24 has a first average unfinished surface profile, indicated by reference number 40, and the second flank 26 has a second average unfinished surface profile, indicated by reference number 42. In the example provided, the first average unfinished surface profile 40 and the second average unfinished surface profile 42 are second order regression lines of their respective unfinished profiles. However, it should be appreciated that other averaging methods may be used without departing from the scope of the present invention.

The stock removal from the first flank 24 is defined as the area between the first unfinished surface profile 32 and the first finished surface profile 34. In other words, the stock removal is the amount of material from the gear tooth 20 that is removed from the first flank 24 during the surface finishing process. The stock removal from the second flank 26 is defined as the area between the second unfinished surface profile 36 and the second finished surface profile 38. The average stock removal from the first flank 24 is defined as the area between the first average unfinished surface profile 40 and the first finished surface profile 34. The average stock removal from the second flank 26 is defined as the area between the second average unfinished surface profile 42 and the second finished surface profile 38. It should be appreciated that stock removal may be calculated for dimensions other than an entire profile without departing from the scope of the present invention.

The actual stock divide 44 is the midline between the first unfinished surface profile 32 and the second unfinished surface profile 36 and is calculated from the average stock removal of the flanks 24 and 26, as will be described in greater detail below. When compared with the finished surface profiles 34 and 38 the actual stock divide 44 indicates how evenly the finishing tool is removing stock from the flanks 24 and 26 of any of the plurality of gear teeth 20. The stock removal and stock divide calculations are used during the finishing process, as will be described in greater detail below.

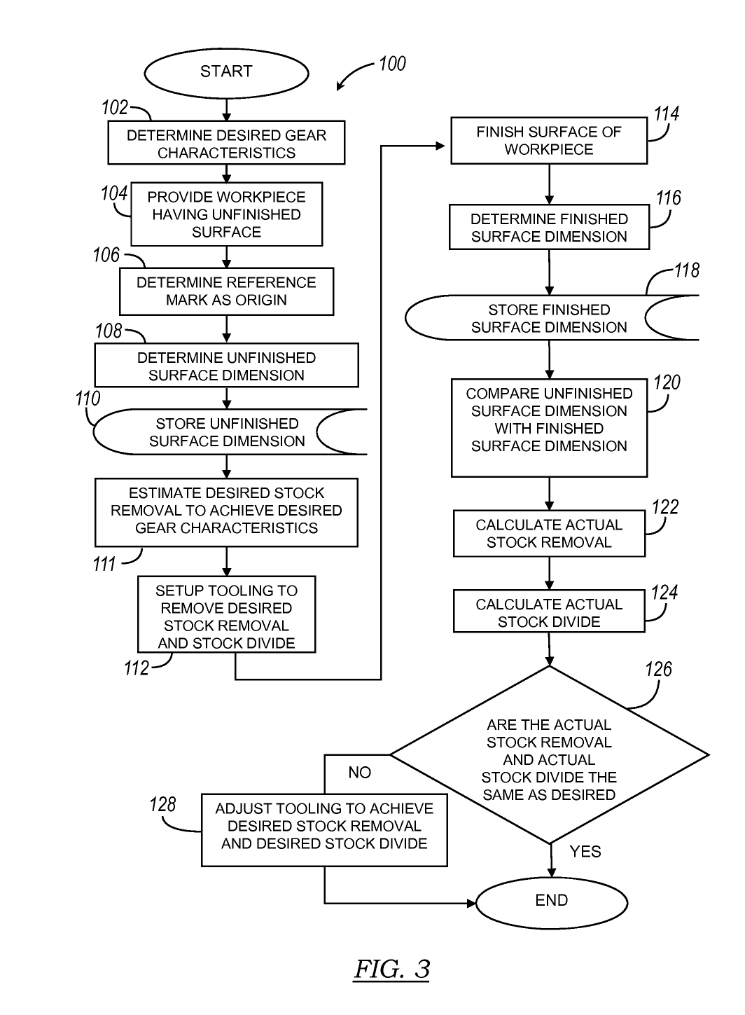

Turning now to FIG. 3, and with continued reference to FIGS. 1 and 2, a method for finishing the outer surface 18 of the workpiece 10 is generally indicated by reference number 100. The method 100 begins at step 102 where desired characteristics of the workpiece are determined. The desired characteristics represent the final characteristics of the workpiece after the finishing operation. The characteristics include, but are not limited to, gear shape, tooth spacing, and tooth surface hardness.

Next, at step 104, an unfinished workpiece 10 is provided. The workpiece 10 has gear teeth 20 each with the unfinished surface profiles 32 and 36. The unfinished workpiece 10 is generally a gear after a rough cut with a roughing tool. As noted above, the unfinished surface profiles 32 and 36 depicted in FIG. 2 are exemplary and may vary between individual gear teeth and between individual workpieces 10.

At step 106 the reference feature 22 is determined on the workpiece 10. The reference feature 22 may be cut into the workpiece 10 or may be formed or applied in other places and by other methods so long as the reference feature 22 identifies a particular location on or orientation of the workpiece 10 before and after the finishing process. Additionally, the reference feature 22 may be pre-existing in the workpiece 10. Accordingly, the reference feature 22 serves as an origin feature on the workpiece 10 to establish a measurement system or coordinate axes.

Next, at step 108, the unfinished surface dimension of the gear tooth 20 is determined relative to the reference feature 22. The determination is preferably performed by dedicated gear measurement machines such as those manufactured by Gleason-M&M, Klingelnberg, Process Equipment Co., Wentzel, and Zeiss. However, gear measurement machines from many other manufacturers may be employed. The gear measurement machine generally includes a measurement tool and a controller used to determine the dimension of at least one of the plurality of gear teeth 20 including both flanks 24 and 26. The measurement tool may be a device to physically trace the surface of the gear or it may be a non-contact measuring device. However, it should be appreciated that machines incorporating other measurement devices may be used without departing from the scope of the present invention. The controller is preferably an electronic device having a preprogrammed digital computer or processor, control logic, memory used to store data, and at least one I/O peripheral. However, other types of controllers may be employed without departing from the scope of the present invention. In the example provided, the gear measurement machine determines multiple dimensions by tracing or measuring the surface profiles 32 and 36 of the workpiece 10 from the root 30 to the tip 28 of at least one of the plurality of gear teeth 20. In another example, the gear tooth 20 is also traced from the first side 12 to the second side 14 (i.e. along the length of the gear tooth 20). The gear measurement machine traces the surface profile 32 three times at discrete planes along the length of the gear tooth 20. Combining the surface profile 32 traces with the trace of the tooth surface along the length of the gear tooth allows for interpolation of the entire surface topography. However, the present invention is not limited to using profiles or topographies, and the method may determine the dimension using as little as a single point on the flank without departing from the scope of the present invention. Accordingly, it should be appreciated that other methods of determining the surface dimension of the gear tooth, such as taking laser measurements, taking discrete points on the surface and inferring the surface profile between these discrete points, or taking fewer or more data points, may be used without departing from the scope of the present invention.

At step 110 the unfinished surface dimension determined in step 108 is stored in a computer or other controller that is in communication with the gear measurement machine. The dimensions are stored as locations relative to the reference feature 22. However, it should be appreciated that other coordinate systems may be used if they are identifiable based on the location of the reference feature 22. If the minimum and maximum dimension are desired, they may be computed based on the stored data.

Estimates of a desired stock removal and a desired stock divide are determined in step 111. The desired stock removal is the estimated desired amount of material to be removed from the flanks 24 and 26 during the finishing process to attempt to produce the desired gear characteristics. The desired stock divide is the desired placement of the finishing tool between the plurality of gear teeth 20 to produce the desired gear characteristics. In the example provided, the estimates are based on industry formulas for determining expected average unfinished profiles 40 and 42 based on roughing and other processes performed to obtain the unfinished workpiece 10. However, the estimates may be based on the actual unfinished surface profiles 32 and 36 determined from step 108. The estimated stock removal and stock divide are selected to produce a finished surface profile on the plurality of gear teeth 20 that is consistent with the design requirements of the workpiece 10.

The tooling and machines employed to finish the workpiece 10 are set up to remove the estimated stock removal and achieve the desired stock divide at step 112. The set up generally includes operations such as determining target size produced in the operation and calibrating the finishing machinery to divide the stock properly. Once the setup is complete, the workpiece 10 is preferably placed into the gear finishing machinery.

An ideal amount of stock is to be removed during the finishing process. The ideal amount would remove enough stock to finish the surface, however it would not take off too much stock, which will wear the finishing tool faster and reduce surface hardness produced in previous heat treatment processes. The desired stock removal and the tool set up determine how close to ideal the stock removal and stock divide are in a finishing process.

At step 114, the workpiece 10 is finished in a gear finishing operation. The gear finishing operation may include gear honing, gear grinding, gear shaving, or other known or unknown gear finishing operations that remove material from the outer surface 18 of the workpiece 10. Once the finishing operation is complete, the gear teeth 20 of the workpiece 10 have the finished surface profiles 34 and 38. Preferably, the hard gear finishing operation is carried out as in normal production without any special setup or cycles based on the measurements obtained from step 108.

Next, at step 116, the finished surface dimension of the workpiece 10 is determined relative to the reference feature 22. The finished surface dimension is determined by tracing along the surface of the gear tooth, as was done in step 108 on the unfinished surface. The finished surface dimension is determined on the same flanks 24 and 26 of the same gear tooth or plurality of gear teeth 20 measured at step 108. The measurement of the finished surface dimension is preferably performed by the same gear measurement machine as in step 108. However, it should be appreciated that a different gear measurement machine may be used. At step 118, the determinations from step 116 are stored in a computer or other controller in communication with the gear measurement machine. The determinations are stored as locations relative to the reference feature 22. However, it should be appreciated that other coordinate systems may be used if they are identifiable based on the location of the reference feature 22.

Next, at step 120, the unfinished surface dimension stored in step 110 is compared to the finished surface dimension stored in step 118 in order to calculate the actual stock removal at step 122 and the actual stock divide at step 124. More specifically, in order to calculate actual stock removed, the controller computes the volume between the unfinished surface dimension and the finished surface dimension of the same gear flank. In the example provided, the average stock removal of a profile is calculated by computing an average unfinished surface profile 40 and finding the area between that average unfinished surface profile 40 and the finished surface profile 34. However, the average stock removal may be based on fewer individual data points and may incorporate the helix dimension without departing from the scope of the present invention. The actual stock divide for a given profile is calculated by first finding the finished tooth midline 43 between the finished surface profiles 34 and 38. The finished tooth midline 43 is then adjusted by the difference between the average left flank stock removal and the average right flank stock removal. The adjusted line represents actual stock divide 44 for the gear tooth 20. The actual stock divide 44 represents how evenly the finishing process is removing stock from the flanks 24 and 26 of each of the gear teeth 20. It should be appreciated that other methods of finding the actual stock divide by using the measurements described above may be used without departing from the scope of the present invention. Steps 120 through 124 may be repeated on as many dimensions of as many gear teeth 20 as desired, or may use less than full profiles or the entire surface topographies in the calculations to determine the total volume of stock removed from the gear tooth 20. For example, repeating the calculations over the entire topographical measurement of the tooth flank would yield the stock removal for the entire surface of the gear flank. It should be understood that either of steps 122 and 124 may be performed without performing the other if only one of the outcomes is desired.

At step 126 the actual stock removal determined at step 122 and the actual stock divide determined at step 124 are compared to the estimated stock removal and desired stock divide from step 102. If the estimated stock removal and desired stock divide are substantially the same as the actual stock removal and actual stock divide then the estimated stock removal and stock divide, and therefore the machine setup, are confirmed to be accurate and the method 100 ends. If the estimated stock removal and the desired stock divide are different from the actual stock removal and the actual stock divide, then the method 100 proceeds to step 128 where the tooling is adjusted. Accordingly, the tooling machines used to finish the workpiece 10 are adjusted based on the difference between the desired stock removal and the actual stock removal, as well as the difference between the desired stock divide and the actual stock divide. The adjustments to the tooling to account for the modified stock removal include changing the target size produced in the operation, altering the heat treatment of the gear after rough cutting, and/or changes to roughing tooling that would modify the rough tooth surface. The adjustments to the tooling to account for the modified stock divide include adjusting the machine control to better synchronize the work piece and tool spindles. It should be appreciated that other assumptions and calculations may be adjusted based on the actual stock removal and stock divide data without departing from the scope of the present invention. The method 100 may be used iteratively on multiple workpieces 10 to improve the estimated stock removal and stock divide assumptions for the finishing process and/or used once on each finishing machine to calibrate individual machines.

The description of the invention is merely exemplary in nature and variations that do not depart from the general idea of the invention are intended to be within the scope of the invention. Such variations are not to be regarded as a departure from the spirit and scope of the invention.

What is claimed is:

1. A method for manufacturing a gear having a plurality of gear teeth, the method comprising:
determining a desired finished gear characteristic;
determining a reference feature on the gear to establish an origin on the gear;
determining an unfinished dimension of a surface of at least one of the plurality of gear teeth relative to the origin;
estimating a desired stock removal that will achieve the desired finished gear characteristic;
finishing the gear using a finishing tool;
determining a finished dimension of the surface of the at least one of the plurality of gear teeth relative to the origin;
determining actual stock removal by comparing the unfinished dimension with the finished dimension; and
comparing the actual stock removal with the desired stock removal.

2. The method of claim 1, wherein determining the reference feature further comprises marking the workpiece.

3. The method of claim 1, wherein determining the reference feature further comprises identifying a pre-existing feature on the gear.

4. The method of claim 1, further comprising adjusting the finishing operation to achieve the desired stock removal during the finishing operation.

5. The method of claim 4, wherein adjusting the finishing operation further comprises changing the target size produced in the finishing operation.

6. The method of claim 1, further comprising determining the actual stock divide by comparing the actual stock removal of a pair of adjacent surfaces of the plurality of gear teeth.

7. The method of claim 6, further comprising adjusting the finishing operation to achieve the desired stock divide in the finishing operation.

8. The method of step 7, wherein adjusting the finishing operation includes compensating for synchronization variation and deflection of the finishing tool using machine control.

9. The method of claim 1, wherein the unfinished dimension is an unfinished profile and the finished dimension is a finished profile, determining the unfinished and finished profiles further comprises tracing the surface from a root to a tip of at least one of the plurality of gear teeth.

10. The method of claim 9, further comprising determining at least three unfinished surface profiles and at least three finished surface profiles of the surface of the at least one of the plurality of gear teeth.

11. The method of claim 9, further comprising tracing the surface along a length of at least one of the plurality of gear teeth.

12. The method of claim 11, further comprising determining substantially an entire surface topography of at least one of the plurality of gear teeth.

13. The method of claim 1, further comprising adjusting roughing tooling based on the actual stock removal.

14. Method of claim 1, further comprising adjusting process parameters based on the actual stock removal.

15. The method of claim 1, further comprising adjusting heat treatment of an unfinished gear based on the actual stock removal.

16. The method of claim 1, wherein the unfinished surface profile and the finished surface profile are on a same plane.

17. The method of claim 1, wherein the finishing step further comprises a gear honing process.

18. The method of claim 1, wherein finishing the gear further includes a gear grinding process.

19. The method of claim 1, wherein finishing the gear further includes a gear shaving process.

20. A method of finishing a gear after a roughing process, the method comprising:
determining a desired finished gear characteristic;
determining a reference feature on the gear to establish an origin;
determining an unfinished surface dimension of at least one of the plurality of gear teeth relative to the origin;
estimating a desired stock removal from the gear that will achieve the desired finished gear characteristic;
finishing the gear using a finishing tool;
determining a finished surface dimension of at least one of the plurality of gear teeth relative to the origin;
determining actual stock removal in the finishing process by comparing the unfinished dimension with the finished dimension;
comparing the actual stock removal with the desired stock removal; and
adjusting at least one of the roughing process and finishing the gear to achieve the desired stock removal by finishing the gear.

21. The method of claim 20, wherein the unfinished surface dimension is an unfinished surface profile and the finished surface dimension is a finished surface profile.

22. The method of claim 21, wherein the unfinished surface profile and the finished surface profile are on a same plane.

23. The method of claim 20, further comprising determining the actual stock divide by comparing the actual stock removal of a pair of adjacent surfaces of the plurality of gear teeth.

24. The method of claim 18, further comprising adjusting the finishing operation to achieve the desired stock divide in the finishing operation.
